(19) United States
(12) Patent Application Publication
(10) Pub. No.: US 2005/0021570 A1
(43) Pub. Date: Jan. 27, 2005

(54) Methods, apparatus, and computer program products for selectively backing up versions of files to a robust storage medium according to file version differences

(76) Inventor: Jim Thompson, Raleigh, NC (US)

Correspondence Address: Robert M. Meeks;Myers Bigel Sibley & Sajovec, P.A., Post Office Box 37428, Raleigh, NC, 27627, US

(21) Appl. No.: 10/926,561

(22) Filed: Aug. 26, 2004

Related U.S. Application Data
(63) Continuation-in-part of application No. 10/353,698, filed on Jan. 28, 2003.

(51) Int. Cl. G06F 7/00

(52) U.S. Cl. 707/200

(57) ABSTRACT

Files on a computer are selectively backed up to an external storage medium included in an uninterruptible power supply (UPS). At least one of a time difference, a file size difference and/or a file content difference between a first version of a file stored on the external storage medium and a second version of the file resident at the computer is determined. The second version of the file is stored on the external storage medium based on whether the determined at least one of a file time difference, a file size difference and/or a file content difference meets a predetermined criterion. For example, the predetermined criterion may be a degree of difference criterion, e.g., a threshold amount by which the file date, files size and/or file content of the first and second versions must differ before the second version is backed up. The invention may be embodied as methods, apparatus and computer program products.

### RELATED APPLICATION

The present application is a continuation-in part application of U.S. patent application Ser. No. 10/353,698, filed Jan. 28, 2003 (Attorney Docket No. 9060-200), the disclosure of which is incorporated herein by reference in its entirety. The present application is related to subject matter disclosed in U.S. patent application Ser. No. ______, entitled “METHODS, APPARATUS, AND COMPUTER PROGRAM PRODUCTS FOR SELECTIVELY BACKING UP FILES TO A ROBUST STORAGE MEDIUM ACCORDING TO PROGRAM ASSOCIATIONS” (Attorney Docket No. 9060-240), filed concurrently herewith and incorporated by reference herein in its entirety.

### BACKGROUND OF THE INVENTION

The present invention relates to computer file management methods, apparatus and computer program products, and more particularly, to file backup methods, apparatus and computer program products.

A personal computer (PC) typically includes a disk drive or other storage device that stores data files that are manipulated by application programs, such as word processor or spreadsheet programs, which execute on the PC. In some environments, PC files may also be stored on an external storage device, such as a disk array, connected to the PC by a network. Backup software may save redundant copies of files stored on the PC's local hard drive to a backup storage device (e.g., tape drive, RAID device, etc.) such that, if the local disk drive fails, files may be restored from information held on the backup storage device. Many of these systems continually monitor the state of files on the local drive, and update the backed up information whenever a change is detected. Some systems also provide for selective backups, e.g., backup limited to particular files or types of files.

### SUMMARY OF THE INVENTION

In some embodiments of the invention, files on a computer are selectively backed up to an external storage medium included in an uninterruptible power supply (UPS). At least one of a time difference, a file size difference and/or a file content difference between a first version of a file stored on the external storage medium and a second version of the file resident at the computer is determined. It is determined whether to store the second version of the file on the external storage medium based on whether the determined at least one of a file time difference, a file size difference and/or a file content difference meets a predetermined criterion. For example, the predetermined criterion may be a degree of difference criterion, such one that requires that an amount by which the file date, files size and/or file content of the first and second versions differ must exceed a predetermined threshold before the second version is backed up.

According to further embodiments, a number of versions of the file previously stored in a predetermined time interval is determined. Determination of whether to store the second version of the file on the external storage medium based on the determined at least one of a time difference, a file size difference and/or a file content difference includes determining whether to store the second version of the file on the external storage medium based on the determined number of versions of the file previously stored in a predetermined time interval.

In additional embodiments of the invention, a user interface configured to accept a user selection of at least one of a time difference criterion, a file size difference criterion, and/or a file content difference criterion is provided. Determination of whether to store the second version of the file on the external storage medium based on whether the determined at least one of a file time difference, a file size difference and/or a file content difference meets a predetermined criterion includes determining whether to store the second version of the file on the external storage medium based on whether the determined at least one of a file time difference, a file size difference and/or a file content difference meets a corresponding one of the at least one of a time difference criterion, a file size difference criterion, and/or a file content difference criterion. The user interface may be configured to allow user selection of a Boolean combination of at least two of a time difference criterion, a file size difference criterion, and a file content difference criterion, and determination of whether to store the second version of the file on the external storage medium based on whether the determined at least one of a time difference, a file size difference and/or a file content difference meets a predetermined criterion may include determining whether to store the second version of the file on the external storage medium based on the Boolean combination of at least two of a time difference criterion, a file size difference criterion, and a file content difference criterion.

According to additional aspects of the invention, files on a computer are selectively backed up to an external storage medium. A difference between a first version of a file stored on the external storage medium and a second version of the file resident at the computer is determined. It is determined whether to store the second version of the file on the external storage medium based on whether the determined difference meets a degree of difference criterion. Determination of whether to store the second version of the file on the external storage medium based on whether the determined difference meets the degree of difference criterion may be preceded by accepting a user selection of the degree of difference criterion.

In further embodiments of the invention, an apparatus includes a computer configured to communicate with an uninterruptible power supply (UPS) that includes the external storage medium. The computer is further configured to provide a version-selective file data storage agent operative to determine at least one of a time difference, a file size difference and a file content difference between a first version of the file stored on the external storage medium and a second version of the file resident at the computer, and to determine whether to store the second version of the file on the external storage medium based on whether the determined at least one of a time difference, a file size difference and/or a file content difference meets a predetermined criterion.

According to additional embodiments of the invention, an apparatus includes a computer configured to provide a version-selective file data storage agent operative to determine a difference between a first version of a file stored on an external storage medium and a second version of the file resident at the computer and to determine whether to store the second version of the file on the external storage medium based on whether the determined difference meets a degree of difference criterion. The version-selective file data storage agent may be operative to accept a user selection of the degree of difference criterion.

Additional embodiments of the invention may provide a computer program product for selectively backing up files on a computer to an external storage medium included in an uninterruptible power supply (UPS). The computer program product includes program code embodied in a computer-readable storage medium, the program code including code configured to determine at least one of a time difference, a file size difference and/or a file content difference between a first version of a file stored on the external storage medium and a second version of the file resident at the computer and code configured to determine whether to store the second version of the file on the external storage medium based on whether the determined at least one of a file time difference, a file size difference and/or a file content difference meets a predetermined criterion. In other embodiments, a computer program product for selectively backing up files on a computer to a external storage medium includes program code including code configured to determine a difference between a first version of a file stored on the external storage medium and a second version of the file resident at the computer and code configured to determine whether to store the second version of the file on the external storage medium based on whether the determined difference meets a degree of difference criterion.

### BRIEF DESCRIPTION OF THE DRAWINGS

FIG. 1 is a schematic diagram illustrating a computer configured to provide a file data storage agent according to some embodiments of the invention.

FIG. 2 is a schematic diagram illustrating a computer configured to provide a file data storage agent according to further embodiments of the invention.

FIGS. 3 and 4 are flowcharts illustrating exemplary file data storage operations according to further embodiments of the invention.

FIG. 5 is a screenshot illustrating an exemplary user interface for a file data storage agent according to further embodiments of invention.

### DETAILED DESCRIPTION OF EXEMPLARY EMBODIMENTS

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Some embodiments of the invention described herein relate to storage of file data from a computer to an external storage device. As referred to herein, “computer” includes any of a variety of computing devices, including, but not limited to, personal computers (PCs), computer workstations, servers, computer-based communications devices, and electronic modules that have computing capabilities.

As will be appreciated by one of skill in the art, the invention may be embodied as apparatus, methods and computer program products. Embodiments of the invention may include hardware and/or software. Furthermore, the invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the invention may be written in an object oriented programming language such as Java®, Smalltalk or C++. However, the computer program code for carrying out operations of the invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The invention is described below with reference to block diagrams and/or operational illustrations of methods, apparatus and computer program products according to various embodiments of the invention. It will be understood that each block of the block diagrams and/or operational illustrations, and combinations of blocks in the block diagrams and/or operational illustrations, can be implemented by analog and/or digital hardware, and/or computer program instructions. These computer program instructions may be provided to a processor of a general purpose computer, special purpose computer, ASIC, and/or other programmable data processing apparatus, such that the instructions, which execute via the processor of the computer and/or other programmable data processing apparatus, create means for implementing the functions/acts specified in the block diagrams and/or operational illustrations. In some alternate implementations, the functions/acts noted in the figures may occur out of the order noted in the block diagrams and/or operational illustrations. For example, two operations shown as occurring in succession may, in fact, be executed substantially concurrently or the operations may sometimes be executed in the reverse order, depending upon the functionality/acts involved.

Co-pending U.S. patent application Ser. No. 10/353,698 describes a UPS with an integrated storage medium that can be used to provide backup storage for a PC or other computer. As described in the aforementioned application, a file data storage agent may be configured to store files on a UPS that includes an integrated storage medium that is powered by the UPS. The file data storage agent may provide a user interface that allows a user to mark selected files for backup. The file data storage agent may responsively store data from the marked files in the external storage medium of the UPS-based file data storage apparatus. Data transfer to the external storage medium may be triggered by, for example, a status change of the UPS, e.g., by a failure or degradation of an AC power source that feeds the UPS, or by other events.

Some exemplary embodiments of the invention described herein relate to selective storage of file versions in such an environment. In a typical application program, “versions” of a file refer to respective states of the file after respective “save” operations. For example, in a typical personal computer (PC) application, such as a word processing or spreadsheet application, a new version of working file (e.g., a document or spreadsheet) that includes user updates (e.g., text additions and/or deletions) is stored to the local disk or networked storage upon user invocation of a “save” operation and/or as a result of a automated “auto-save” procedure.

Some embodiments of the invention arise from a realization that, for a backup storage application such that that described in the aforementioned U.S. patent application Ser. No. 10/353,698, the amount of backup storage may be limited and, accordingly, it may be desirable to store only those versions of a file that are significant to the user, rather than retaining all versions of a file. For example, under certain circumstances, a user may save nearly identical versions of a file due to an “auto save” or other automatic file versioning procedure. Retaining all or a significant number of such versions of a file may be problematic for several reasons. Multiple versions of a file consume more disk space, make management (such as recovery) more difficult due to the fact that many (virtually identical) versions are present, and, if there is a limit as to the number of versions that can be stored on the backup storage medium, the versions stored on the external storage medium could end up being essentially identical, while a significantly different version of the same file could be lost

According to some embodiments of the invention, selectively backing up files to such a device using a version degree of difference criterion can create an increasingly reduced and increasingly valuable selection space. The degree of difference may relate, for example, to differences in file time, file size and/or file content between versions, and may be adjusted responsive to user input. Such selection criteria can be further constrained by limiting the number of versions backed up in a given period. For example, it may be advantageous to allow no more than 2 versions meeting the file criteria to be stored in a 24-hour period. Such interval criteria may be made even more flexible, e.g., it may be advantageous to allow no more than 24 versions per month, no more than 7 per week, no more than 3 per day, with an unlimited number allowed to be stored on Wednesdays, etc.

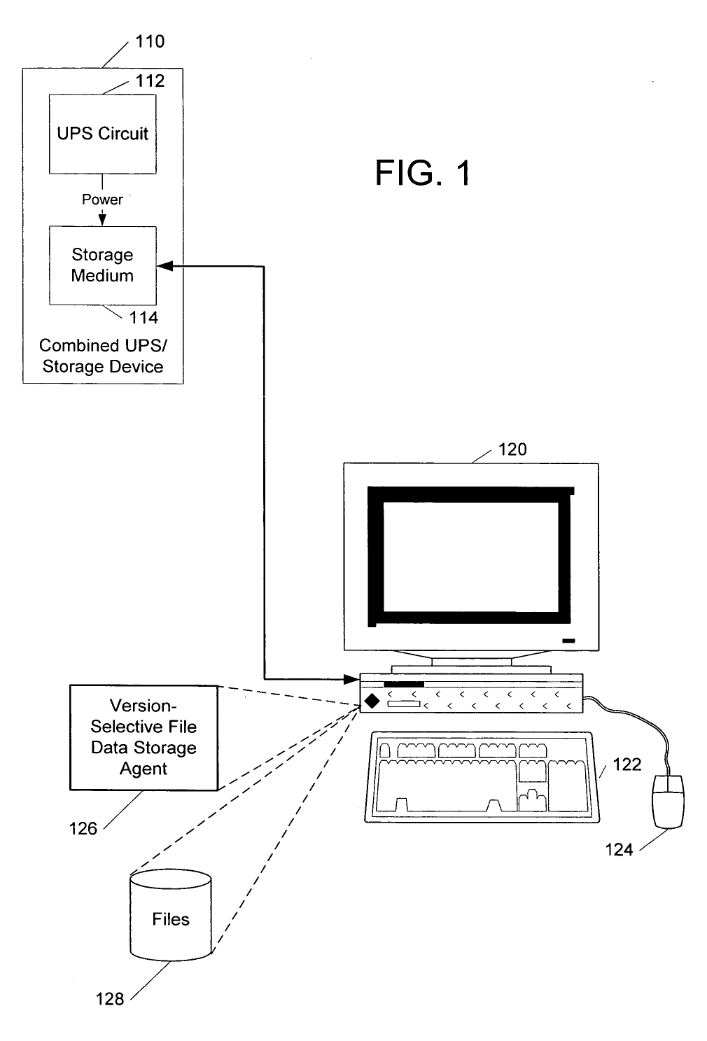

FIG. 1 illustrates an apparatus according to some embodiments of the present invention, in particular, a computer 120 configured to selectively store versions of files 128 resident on the computer 120 on an external storage medium 114 integrated in a UPS 110. The UPS 110 includes a UPS circuit 112 that powers the storage medium 114 to provide robust backup storage. The computer 120 is configured to provide a version-selective file data storage agent 126 that selectively backs up versions of the files 128 based on comparisons with versions of the files 128 previously stored on the storage medium 114.

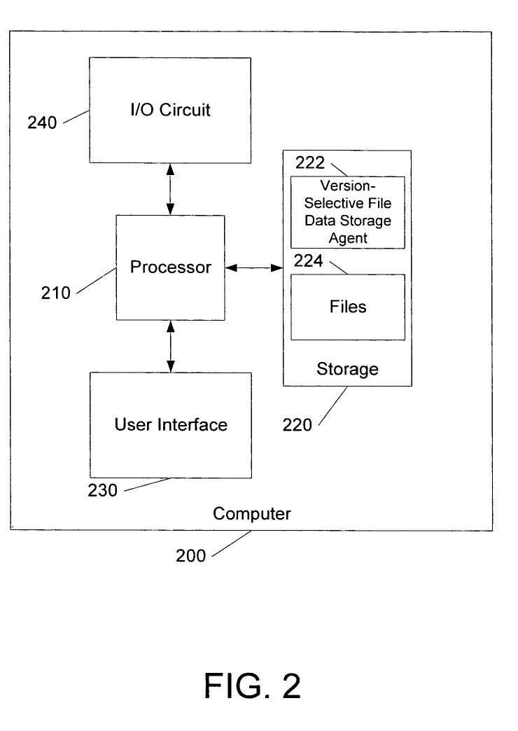

FIG. 2 illustrates an exemplary implementation of a version-selective file data storage agent. A computer 200 includes a processor, e.g., a microprocessor, that is operatively associated with an input/output (I/O) circuit 240 and a user interface circuit 230. It will be appreciated that the I/O circuit 240 may include, for example, wireline, optical and/or radio interface circuitry that enables the processor 210 to communicate with external devices, such as the integrated UPS/storage medium 110 of FIG. 1. The user interface circuit 230 may include, for example, display and input device circuitry, e.g., mouse and/or keyboard.

The computer 200 further includes storage 220 that is configured to store data and program code that is executed or manipulated by the processor 210. It will be appreciated that the storage 220 may include, for example, random access memory (RAM), read-only memory (ROM), and bulk storage, such as a magnetic disk, bubble memory. As shown, a version-selective file data storage agent 222 may include an application program that is resident in the memory 222 and executable on the processor 210. Files 224 that are created and/or manipulated by other application programs (not shown) and selectively backed up by the version-selective file data storage agent may also be stored in the storage 220.

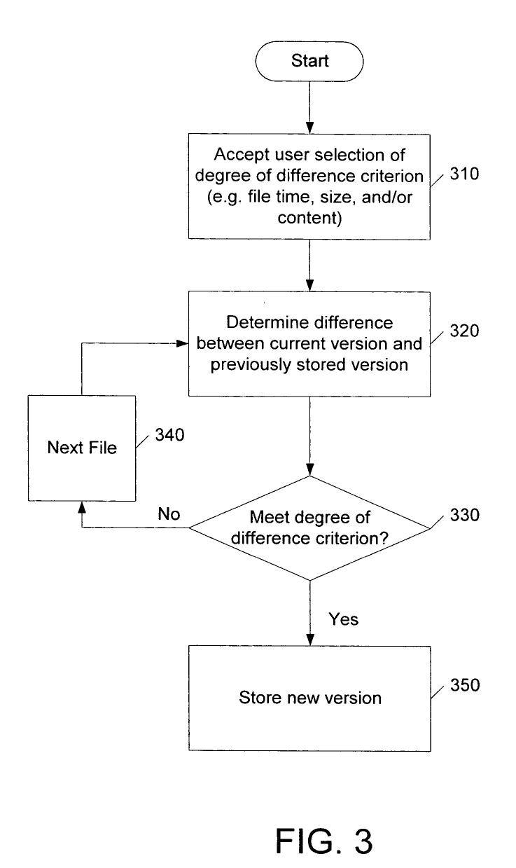

FIG. 3 illustrates exemplary version-selective backup operations according to some embodiments of the present invention. The illustrated operations may be executed on a computer, such as those shown in FIGS. 1 and 2. The computer accepts a user selection of a degree of difference criterion (block 310). The computer determines a difference between a current version of a file resident on the computer and a version previously stored on the external storage medium (block 320). If the difference meets the user-specified degree of difference criterion, the current version is stored on the external storage medium (block 350). If not, a next file may be considered (block 340).

In various embodiments of the invention, there may be one or more degree of difference criteria, and these criteria may take several forms. For example, in some embodiments, the degree of difference criteria may relate to file time (e.g., edit or creation date), file size (e.g., number of bytes), or file content (e.g., number of differing bytes). In some embodiments, for example, backup of a particular version of a file may occur only if the current version differs in file time by more than a predetermined amount of time, differs in size by more than a predetermined number of information units (e.g., bytes), and/or differs in content by more than a predetermined number of information units. These criteria could be used alone or in various logical combinations.

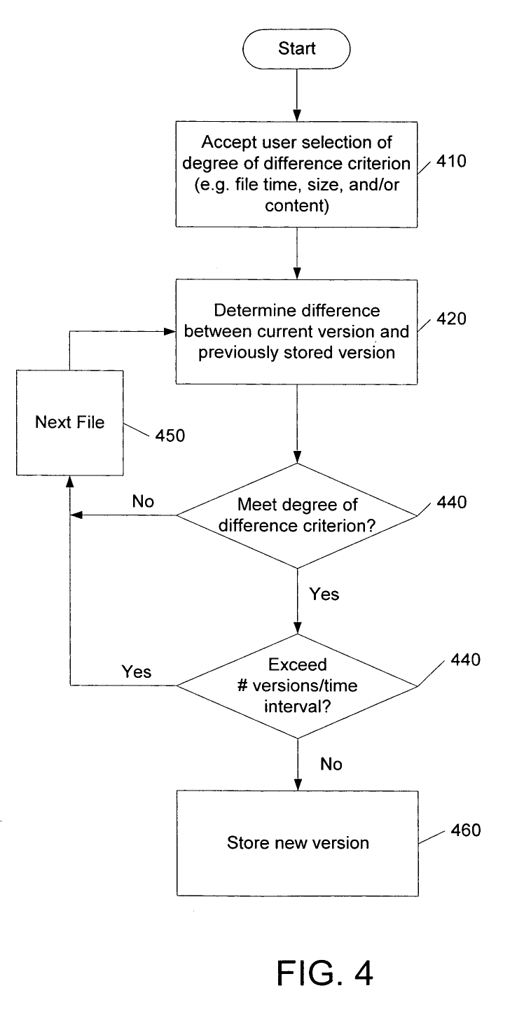

FIG. 4 illustrates exemplary file backup operations according to further embodiments of the invention. The computer accepts a user selection of a degree of difference criterion (block 410). The computer determines a difference between a current version of file resident and the computer and a version previously stored on the external storage medium (block 420). If the difference fails to meet the user-specified degree of difference criterion, another file may be considered (block 450). If the difference meets the criterion, however, the computer next determines whether storage of the current version would exceed a limit on the number of versions that can be stored in a predetermined interval (block 440). If this criterion is met, the current version is stored on the external storage medium (block 460). If not, a next file may be considered (block 450).

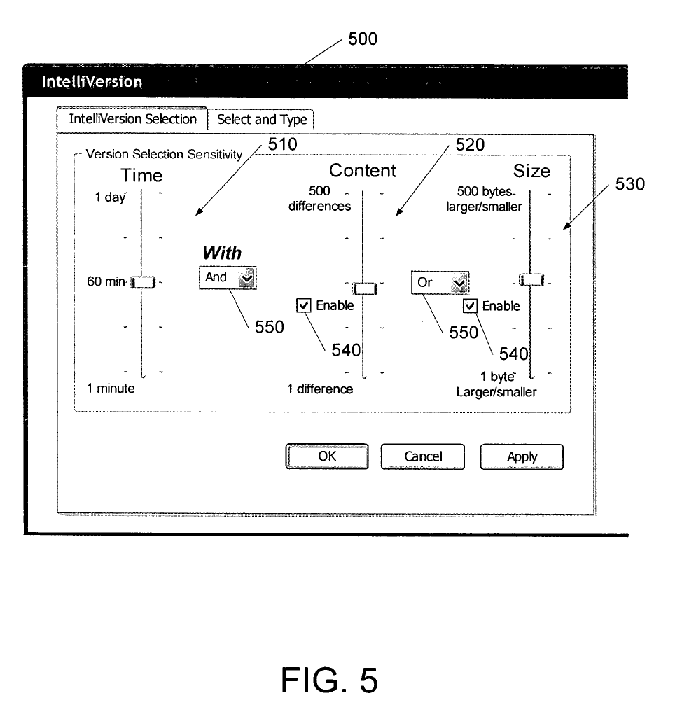

FIG. 5 is a computer screen shot illustrating an exemplary user interface that may be provided by a version-selective file data storage agent according to some embodiments of the invention. In particular, the user interface provides a display window 500 that includes respective graphical sliders 510, 520, 530 that allow a user (via a mouse or similar instrumentality) to selectively set file time, file content and/or file size criteria for selective version backup. Selection boxes 540 may be provided to allow a user to activate and deactivate selected ones the version selection criteria, and pull-down menus 550 may be provided to allow logical combinations of the various criteria.

The flow diagrams, block diagrams and screenshots of FIGS. 1-5 illustrate architecture, functionality, and operations of possible implementations of apparatus, methods and computer program products according to various embodiments of the present invention. It should also be noted that, in some alternative implementations, the acts noted in the diagrams may occur out of the order noted in the figures. For example, two operations shown in succession may, in fact, be executed substantially concurrently, or the operations may sometimes be executed in the reverse order, depending upon the functionality involved.

In the drawings and specification, there have been disclosed typical illustrative embodiments of the invention and, although specific terms are employed, they are used in a generic and descriptive sense only and not for purposes of limitation, the scope of the invention being set forth in the following claims.

In the drawings and specification, there have been disclosed exemplary embodiments of the invention. Although specific terms are employed, they are used in a generic and descriptive sense only and not for purposes of limitation, the scope of the invention being defined by the following claims.

1. A method of selectively backing up files on a computer to a external storage medium included in an uninterruptible power supply (UPS), the method comprising:
determining at least one of a time difference, a file size difference and/or a file content difference between a first version of a file stored on the external storage medium and a second version of the file resident at the computer; and
determining whether to store the second version of the file on the external storage medium based on whether the determined at least one of a file time difference, a file size difference and/or a file content difference meets a predetermined criterion.

2. A method according to claim 1, wherein the predetermined criterion comprises a degree of difference criterion.

3. A method according to claim 1, further comprising storing the second version of the file if a time for the second version follows a time for the first version by at least a predetermined amount of time.

4. A method according to claim 1, further comprising storing the second version of the file if a file size of the second version differs from a file size for the first version by at least a predetermined amount.

5. A method according to claim 1, further comprising storing the second version of the file if a first one of the first and second versions has at least a predetermined number of information units not present in a second one of the first and second versions.

6. A method according to claim 1, further comprising determining a number of versions of the file previously stored in a predetermined time interval, and wherein determining whether to store the second version of the file on the external storage medium based on the determined at least one of a time difference, a file size difference and/or a file content difference comprises determining whether to store the second version of the file on the external storage medium based on the determined number of versions of the file previously stored in a predetermined time interval.

7. A method according to claim 1, further comprising generating a user interface configured to accept a user selection of at least one of a time difference criterion, a file size difference criterion, and/or a file content difference criterion, and wherein determining whether to store the second version of the file on the external storage medium based on whether the determined at least one of a file time difference, a file size difference and/or a file content difference meets a predetermined criterion comprises determining whether to store the second version of the file on the external storage medium based on whether the determined at least one of a file time difference, a file size difference and/or a file content difference meets a corresponding one of the at least one of a time difference criterion, a file size difference criterion, and/or a file content difference criterion.

8. A method according to claim 7, wherein the user interface is configured to allow user selection of a Boolean combination of at least two of a time difference criterion, a file size difference criterion, and a file content difference criterion, and wherein determining whether to store the second version of the file on the external storage medium based on whether the determined at least one of a time difference, a file size difference and/or a file content difference meets a predetermined criterion comprises determining whether to store the second version of the file on the external storage medium based on the Boolean combination of at least two of a time difference criterion, a file size difference criterion, and a file content difference criterion.

9. A method of selectively backing up files on a computer to a external storage medium, the method comprising:
determining a difference between a first version of a file stored on the external storage medium and a second version of the file resident at the computer; and
determining whether to store the second version of the file on the external storage medium based on whether the determined difference meets a degree of difference criterion.

10. A method according to claim 9, wherein determining whether to store the second version of the file on the external storage medium based on whether the determined difference meets the degree of difference criterion is preceded by accepting a user selection of the degree of difference criterion.

11. A method according to claim 10, wherein accepting a user selection of the degree of difference criterion comprises accepting a user selection of a Boolean combination of a plurality of degree of difference criteria.

12. A method according to claim 10, further comprising providing a user interface configured to allow user variation of a graphical representation of the degree of difference criterion.

13. A method according to claim 9, wherein the external storage medium is included in an uninterruptible power supply (UPS).

14. A method according to claim 9, wherein the degree of difference criterion comprises at least one of a file date difference criterion, a file size difference criterion, and/or a file content difference criterion.

15. A method according to claim 9, further comprising determining a number of versions of the file stored in a predetermined time interval, and wherein determining whether to store the second version of the file on the external storage medium based on whether the determined difference meets the degree of difference criterion comprises determining whether to store the second version of the file on the external storage medium based on the determined number of versions of the file stored in the predetermined time interval.

16. An apparatus, comprising:
a computer configured to communicate with an uninterruptible power supply (UPS) that includes the external storage medium, the computer further configured to provide a version-selective file data storage agent operative to determine at least one of a time difference, a file size difference and a file content difference between a first version of the file stored on the external storage medium and a second version of the file resident at the computer, and to determine whether to store the second version of the file on the external storage medium based on whether the determined at least one of a time difference, a file size difference and/or a file content difference meets a predetermined criterion.

17. An apparatus according to claim 16, wherein the predetermined criterion comprises a degree of difference criterion.

18. An apparatus according to claim 16, wherein the version-selective file data storage agent is operative to store the first version of the file if a time for the second version follows a time for the first version by at least a predetermined amount of time.

19. An apparatus according to claim 16, wherein the version-selective file data storage agent is operative to store the second version of the file if a file size of the second version differs from a file size of the first version by at least a predetermined amount.

20. An apparatus according to claim 16, wherein the version-selective file data storage agent is operative to store the second version of the file if a first one of the first and second versions has at least a predetermined number of information units not present in a second one of the first and second versions.

21. An apparatus according to claim 16, wherein the version-selective file data storage agent is further operative to determine a number of versions of the file previously stored in a predetermined time interval, and to determine whether to store the second version of the file on the external storage medium based on the determined number of versions of the file previously stored in a predetermined time interval.

22. An apparatus according to claim 16, wherein the version-selective file data storage agent is further operative to generate a user interface configured to accept a user selection of at least one of a time difference criterion, a file size difference criterion, and a file content difference criterion.

23. An apparatus according to claim 22, wherein the user interface is configured to allow user selection of a Boolean combination of at least two of a time difference criterion, a file size difference criterion, and a file content difference criterion.

24. An apparatus, comprising:
a computer configured to implement a version-selective file data storage agent operative to determine a difference between a first version of a file stored on an external storage medium and a second version of the file resident at the computer and to determine whether to store the second version of the file on the external storage medium based on whether the determined difference meets a degree of difference criterion.

25. An apparatus according to claim 24, wherein the version-selective file data storage agent is operative to accept a user selection of the degree of difference criterion.

26. An apparatus according to claim 25, wherein the version-selective file data storage agent is operative to accept user selection of a Boolean combination of a plurality of degree of difference criteria.

27. An apparatus according to claim 25, wherein the version-selective file data storage agent is operative to provide a user interface configured to allow user variation of a graphical representation of the degree of difference criterion.

28. An apparatus according to claim 25, wherein the computer is configured to communicate with an uninterruptible power supply (UPS) that includes the external storage medium.

29. An apparatus according to claim 24, wherein the degree of difference significance criterion comprises at least one of a file date difference criterion, a file size difference criterion, and/or a file content difference criterion.

30. An apparatus according to claim 24, wherein the version-selective file data storage agent is further operative to determine number of versions of the file stored in a predetermined time interval and to determine whether to store the second version of the file on the external storage medium based on the determined number of versions of the file stored in the predetermined time interval.

31. A computer program product for selectively backing up files on a computer to an external storage medium included in an uninterruptible power supply (UPS), the computer program product comprising program code embodied in a computer-readable storage medium, the program code comprising:
code configured to determine at least one of a time difference, a file size difference and/or a file content difference between a first version of a file stored on the external storage medium and a second version of the file resident at the computer; and
code configured to determine whether to store the second version of the file on the external storage medium based on whether the determined at least one of a file time difference, a file size difference and/or a file content difference meets a predetermined criterion.

32. A computer program product according to claim 31, wherein the predetermined criterion comprises a degree of difference criterion.

33. A computer program product according to claim 31, wherein the program code further comprises code configured to generate a user interface that accepts a user selection of at least one of a time difference criterion, a file size difference criterion, and a file content difference criterion.

34. A computer program product according to claim 33, wherein the user interface allows user selection of a Boolean combination of at least two of a time difference criterion, a file size difference criterion, and a file content difference criterion.

35. A computer program product for selectively backing up files on a computer to a external storage medium, the computer program product comprising program code embodied in a computer-readable storage medium, the program code comprising:
code configured to determine a difference between a first version of a file stored on the external storage medium and a second version of the file resident at the computer; and
code configured to determine whether to store the second version of the file on the external storage medium based on whether the determined difference meets a degree of difference criterion.

36. A computer program product according to claim 35, wherein the degree of difference significance criterion comprises at least one of a file date difference criterion, a file size difference criterion, and/or a file content difference criterion.
